(19) United States
(12) Patent Application Publication
(10) Pub. No.: US 2025/0383726 A1
(43) Pub. Date: Dec. 18, 2025

(54) REDUCING SLIDER POSITION JITTER IN AN ELECTRONIC DEVICE

(71) Applicant: Qorvo US, Inc., Greensboro, NC (US)

(72) Inventors: IIya Umansky, San Jose, CA (US); Omar Leung, Palo Alto, CA (US); Victor Sutardja, Saratoga, CA (US)

(21) Appl. No.: 19/214,233

(22) Filed: May 21, 2025

Related U.S. Application Data
(60) Provisional application No. 63/659,926, filed on Jun. 14, 2024.
(60) Provisional application No. 63/709,160, filed on Oct. 18, 2024.

(51) Int. Cl. G06F 3/0354; G06F 3/01

(52) U.S. Cl. CPC G06F 3/03548; G06F 3/016

(57) ABSTRACT

Reducing slider position jitter in an electronic device is provided. In embodiments disclosed herein, the electronic device first determines raw position values and raw force values of an external force based on data collected via force sensors. Accordingly, the electronic device performs a series of post processing steps on the raw position values and the raw force values to determine a new position value of the external force. Specifically, the electronic device determines the new position value based on a step value so determined to reduce the slider position jitter. Subsequently, the electronic device can generate an indication(s) (e.g., position change and/or haptic trigger) based on the determined new position value. As a result, the electronic device can effectively reduce the slider position jitter and improve a user experience.

### RELATED APPLICATIONS

This application claims the benefit of U.S. provisional patent application Ser. No. 63/659,926, filed on Jun. 14, 2024, and U.S. provisional patent application Ser. No. 63/709,160, filed on Oct. 18, 2024, the disclosures of which are hereby incorporated herein by reference in their entireties.

### FIELD OF THE DISCLOSURE

The technology of the disclosure relates generally to reducing slider position jitter in an electronic device.

### BACKGROUND

User-interactive electronic devices, such as smartphones, tablets, smart watches, and in-home/in-vehicle electronic devices, have become increasingly popular in current society for supporting a variety of applications. The prevalence of these user-interactive electronic devices is driven in part by the many functions that are now enabled on such devices. Simply put, today's user-interactive electronic devices have evolved from single function devices into sophisticated multimedia centers as a result of their increased processing capabilities.

The user-interactive electronic devices can be designed to interact with an end user by multiple means. Among them, a slider bar/button is commonly employed to enable such functions as volume control, brightness adjustment, and so on. Often times, a force sensor(s) is used to detect an external force (e.g., user finger press) applied onto the slider bar/button to thereby trigger an intended response.

Objectively, a lower minimum level of the external force required to trigger the intended response can lead to a better user experience. However, lowering the minimum level of the external force can also make it harder to precisely determine a position of the external force due to noise and/or interference. Specifically, the noise and/or interference can distort the external force detected by the force sensor(s) to cause slider position jitter, wherein the position falsely oscillates while the external force remains still. As such, it is desired to reduce the slider position jitter to help improve the user experience.

### SUMMARY

Embodiments of the disclosure relate to reducing slider position jitter in an electronic device. In embodiments disclosed herein, the electronic device first determines raw position values and raw force values of an external force based on data collected via force sensors. Accordingly, the electronic device performs a series of post processing steps on the raw position values and raw force values to determine a new position value of the external force. Specifically, the electronic device determines the new position value based on a step value so determined to reduce the slider position jitter. Subsequently, the electronic device can generate an indication(s) (e.g., position change and/or haptic trigger) based on the determined new position value. As a result, the electronic device can effectively reduce the slider position jitter and improve a user experience.

In one aspect, an electronic device is provided. The electronic device includes multiple force sensors. Each of the multiple force sensors is coupled to a slider. Each of the multiple force sensors is configured to generate a respective one of multiple sensory signals in response to an external force being applied on the slider. The electronic device also includes a raw data processing circuit. The raw data processing circuit is configured to determine a raw position value and a raw force value of the external force based on the multiple sensory signals. The raw data processing circuit is also configured to linearly map the raw force value to an alpha raw force value inversely related to the raw force value. The electronic device also includes a post processing circuit. The post processing circuit is configured to determine a new position value based on the raw position value and the alpha raw force value. The post processing circuit is also configured to determine a relative position change between the new position value and a current position value based on a step value determined to reduce position jitter of the slider.

In another aspect, a method for reducing slider position jitter in an electronic device is provided. The method includes generating multiple sensory signals in response to an external force being applied on a slider. The method also includes determining a raw position value and a raw force value of the external force based on the multiple sensory signals. The method also includes linearly mapping the raw force value to an alpha raw force value inversely related to the raw force value. The method also includes determining a new position value based on the raw position value and the alpha raw force value. The method also includes determining a relative position change between the new position value and a current position value based on a step value determined to reduce position jitter of the slider.

In another aspect, a wireless device is provided. The wireless device includes multiple force sensors. Each of the multiple force sensors is coupled to a slider. Each of the multiple force sensors is configured to generate a respective one of multiple sensory signals in response to an external force being applied on the slider. The wireless device also includes a raw data processing circuit. The raw data processing circuit is configured to determine a raw position value and a raw force value of the external force based on the multiple sensory signals. The raw data processing circuit is also configured to linearly map the raw force value to an alpha raw force value inversely related to the raw force value. The wireless device also includes a post processing circuit. The post processing circuit is configured to determine a new position value based on the raw position value and the alpha raw force value. The post processing circuit is also configured to determine a relative position change between the new position value and a current position value based on a step value determined to reduce position jitter of the slider.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary electronic device configured according to embodiments of the present disclosure to reduce slider position jitter;

FIG. 2 is a schematic diagram of an exemplary communication device that can function as the electronic device of FIG. 1; and

FIG. 3 is a flowchart of an exemplary process for reducing slider position jitter in the electronic device of FIG. 1 and the communication device of FIG. 2.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to reducing slider position jitter in an electronic device. In embodiments disclosed herein, the electronic device first determines raw position values and raw force values of an external force based on data collected via force sensors. Accordingly, the electronic device performs a series of post processing steps on the raw position values and raw force values to determine a new position value of the external force. Specifically, the electronic device determines the new position value based on a step value so determined to reduce the slider position jitter. Subsequently, the electronic device can generate an indication(s) (e.g., position change and/or haptic trigger) based on the determined new position value. As a result, the electronic device can effectively reduce the slider position jitter and improve the user experience.

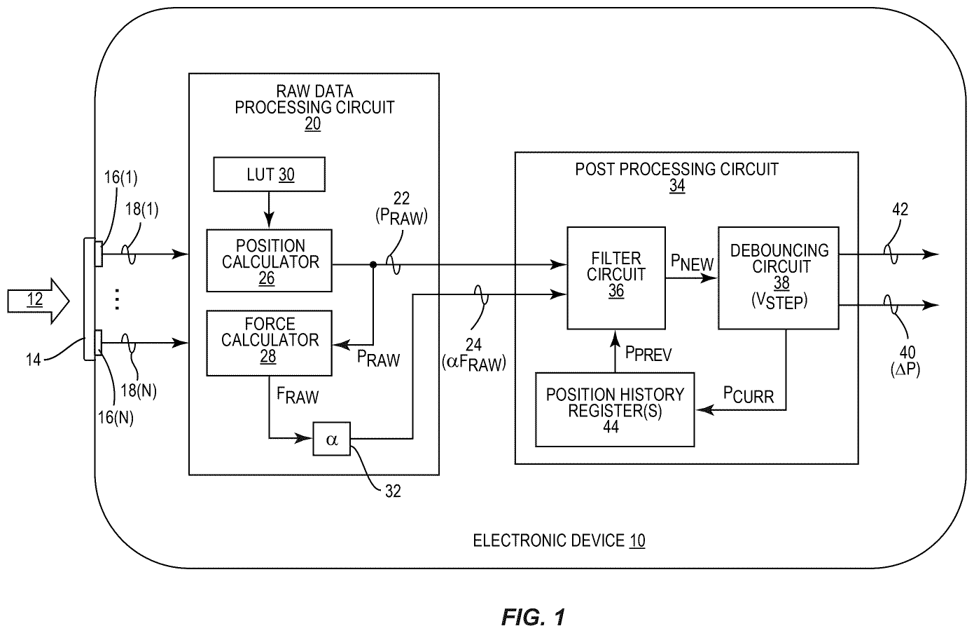

FIG. 1 is a schematic diagram of an exemplary electronic device 10 configured according to embodiments of the present disclosure to reduce slider position jitter when an external force 12 is applied to a slider 14. Herein, the electronic device 10 can be a user-interactive electronic device, including but not limited to a smartphone, a smartwatch, a tablet, a laptop computer, and an in-vehicle infotainment console. In a non-limiting example, the external force 12 applied onto the slider 14 can cause the electronic device 10 to perform an intended task, such as volume control, brightness adjustment, zoom-in/out, radio station selection, and so on.

To detect the external force 12 applied onto the slider 14, a number of force sensors 16(1)-16(N) are provided in the electronic device 10 and each is coupled to the slider 14. Each of the force sensors 16(1)-16(N) is configured to generate a respective one of multiple sensory signals 18(1)-18(N) when the external force 12 is applied on the slider 14.

The sensory signals 18(1)-18(N) are received and processed by a raw data processing circuit 20 to thereby determine a first raw data signal 22 indicating a raw position value P_{RAW} and a second raw data signal 24 indicating a raw force value F_{RAW}. In an embodiment, the raw data processing circuit 20 includes a position calculator circuit 26 and a force calculator circuit 28. The position calculator circuit 26 is configured to determine the raw position value P_{RAW} based on the sensory signals 18(1)-18(N). In an embodiment, the raw data processing circuit 20 may be configured to include a lookup table (LUT) 30. Accordingly, the position calculator circuit 26 can determine the raw position value P_{RAW} based on the LUT 30 and the sensory signals 18(1)-18(N).

The force calculator circuit 28 is configured to determine the raw force value F_{RAW} based on the determined raw position value P_{RAW} and the sensory signals 18(1)-18(N). In an embodiment, a transfer function 32 may be provided in the raw data processing circuit 20 to linearly map the raw force value F_{RAW} into an alpha force value αF_{RAW} based on an assumption that the determined raw position value P_{RAW} has not changed. Herein, the alpha force value αF_{RAW} is inversely related to the raw force value F_{RAW}, with a higher value of the raw force value F_{RAW} being mapped to a lower value of the alpha force value αF_{RAW}. In this regard, if the raw force value F_{RAW} ranges from 50 grams (g) to 400 grams (g), the corresponding alpha force value αF_{RAW} will range from 0.99 to 0.5. Accordingly, the raw force value F_{RAW} of 50 g will be mapped to the alpha force value αF_{RAW} of 0.99, whereas the raw force value F_{RAW} of 400 g will be mapped to the alpha force value F_{RAW} of 0.5.

According to an embodiment of the present disclosure, the raw position value P_{RAW} and the alpha force value αF_{RAW} will be further processed by a post processing circuit 34 to determine a new position value P_{NEW}. Specifically, the new position value P_{NEW} is further processed to determine a relative position change ΔP between the new position value P_{NEW} and a current position value P_{CURR} based on a step value V_{STEP}. Herein, the step value V_{STEP} is predetermined to help reduce position jitter of the slider 14. As a result, the electronic device 10 can be more responsive to the external force 12 for a better user experience.

Herein, the post processing circuit 34 includes a filter circuit 36 and a debouncing circuit 38. In an embodiment, the filter circuit 36 can include a single-order infinite impulse response (IIR) low-pass filter (not shown) with a coefficient determined based on the alpha force value αF_{RAW}. Given that the alpha force value αF_{RAW} is determined based on the raw force value F_{RAW}, which is dependent on the raw position value P_{RAW}, the alpha force value αF_{RAW} is also dependent on the raw position value P_{RAW}. The filter circuit 36 is configured to apply the single-order IIR low-pass filter to the raw position value P_{RAW} to thereby determine the new position value P_{NEW} based on a current position value P_{CURR}.

As an example, the filter circuit 36 can be initialized to start with the current position value P_{CURR} of 0.44. Using a naive rounding implementation, the current position value P_{CURR} will be changed to 0.46 when the new position value P_{NEW} equals 0.451 and goes back to 0.44 if the new position value P_{NEW} goes down to 0.449. Such a position vibration can create visible position jitter that can compromise the user experience.

As such, the debouncing circuit 38 is configured to output a position change signal 40 to indicate a position change ΔP of the new position value P_{NEW} relative to the current position value P_{CURR}. Specifically, the debouncing circuit 38 keeps track of the current position value P_{CURR} being displayed and only outputs the position change signal 40 to cause the new position value P_{NEW} to be displayed when the position change ΔP is more than a step value V_{STEP}. In a non-limiting example, the step value V_{STEP} can be equal to 1.5×0.02. Herein, the debouncing circuit 38 may reduce the slider position jitter associated with the new position value P_{NEW} using a well-known Schmitt Trigger and the step value V_{STEP}. As an example, if the current position value P_{CURR} being displayed is 0.44, then the new position value P_{NEW} must increase to 0.47 (0.44+1.5×0.02=0.47) to thereby cause the new position value P_{NEW} to be displayed as 0.46. In the other direction, if the current position value P_{CURR} being displayed is 0.46, then the new position value P_{NEW} must decrease to 0.43 (0.46c−1.5×0.02=0.43) to thereby cause the new position value P_{NEW} to be displayed as 0.44. In this regard, the step value V_{STEP} can function as a threshold of the Schmitt Trigger to help reduce the slider position jitter associated with the new position value P_{NEW}.

Accordingly, the debouncing circuit 38 can output the position change signal 40 to indicate the relative position change ΔP between the new position value P_{NEW} and the current position value P_{CURR}. In a non-limiting example, the relative position change ΔP can be a positive value to indicate an increase (e.g., cursor up), a negative value to indicate a decrease (e.g., cursor down), or a zero value to indicate no-change (e.g., cursor standstill).

In an embodiment, the debouncing circuit 38 may further output a haptic trigger 42 when the relative position change ΔP is not equal to zero (ΔP≠0). The haptic trigger 42 may be used to provide the user with a haptic response (e.g., vibration) as a result of applying the external force 12 to the slider 14.

In an embodiment, the post processing circuit 34 may further include a position history register(s) 44 that keeps track of the position change and feeds the filter circuit 36 with a previous position value P_{PREV}. The position history register(s) 44 is initialized to a selected initial position value when the electronic device 10 is power cycled or reset. Subsequently, the position history register(s) 44 will be continuously updated by the debouncing circuit 38 with the then current position value P_{CURR}. Accordingly, the position history register(s) 44 can provide the previous position value P_{PREV} to the filter circuit 36 based on whatever value is stored therein.

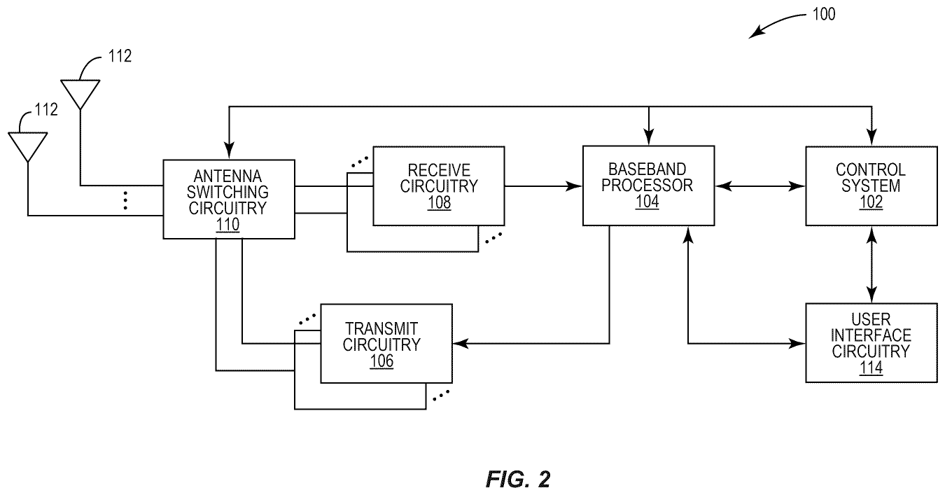

In a non-limiting example, the electronic device 10 of FIG. 1 can be a communication device such as a smartphone. In this regard, FIG. 2 is a schematic diagram of an exemplary communication device 100 that can function as the electronic device 10 of FIG. 1.

Herein, the communication device 100 can be any type of communication device, such as mobile terminal, smart watch, tablet, computer, navigation device, access point, base station (e.g., eNB, gNB, etc.), and any other type of wireless communication device that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

In an embodiment, the slider 14 and the force sensors 16(1)-16(N) may be provided in the user interface circuitry 114. The raw data processing circuit 20 and the post processing circuit 34 may be provided in the control system 102 or the baseband processor 104. Understandably, it is also possible to provide the slider 14, the force sensors 16(1)-16(N), the raw data processing circuit 20, and the post processing circuit 34 elsewhere in the communication device 100 as needed.

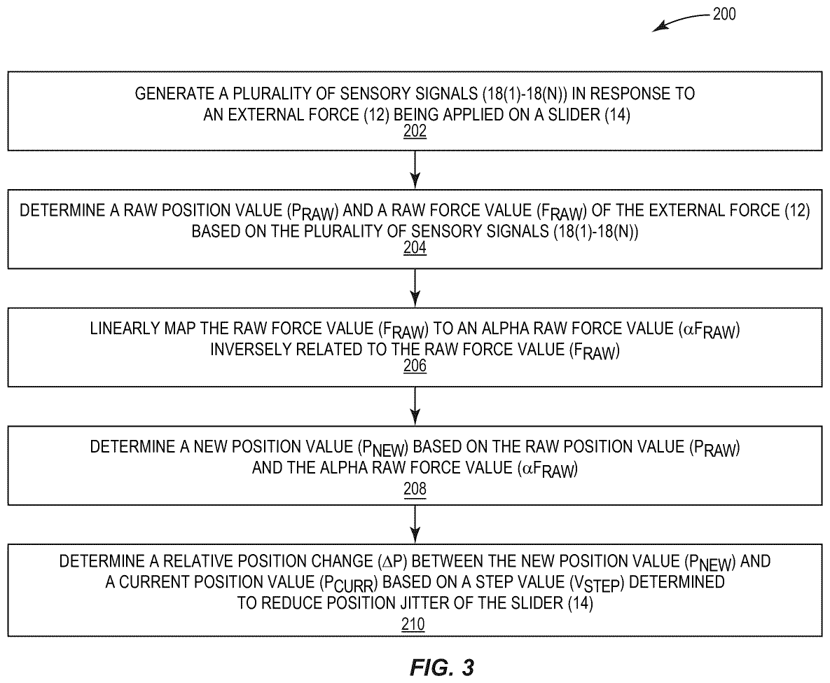

In an embodiment, the electronic device 10 of FIG. 1 and the communication device 100 of FIG. 2 can be configured to reduce slider position jitter in accordance with a process. In this regard, FIG. 3 is a flowchart of an exemplary process 200 for reducing the slider position jitter in the electronic device 10 of FIG. 1 and the communication device 100 of FIG. 2.

Herein, the process 200 includes generating the sensory signals 18(1)-18(N) in response to the external force 12 being applied on the slider 14 (step 202). The process 200 also includes determining the raw position value P_{RAW} and the raw force value F_{RAW} of the external force 12 based on the sensory signals 18(1)-18(N) (step 204). The process 200 also includes linearly mapping the raw force value F_{RAW} to the alpha raw force value αF_{RAW} inversely related to the raw force value F_{RAW} (step 206). The process 200 also includes determining the new position value P_{NEW} based on the raw position value P_{RAW} and the alpha raw force value αF_{RAW} (step 208). The process 200 also includes determining the relative position change ΔP between the new position value P_{NEW} and the current position value P_{CURR} based on the step value V_{STEP} determined to reduce the position jitter of the slider 14 (step 210).

Those skilled in the art will recognize improvements and modifications to the preferred embodiments of the present disclosure. All such improvements and modifications are considered within the scope of the concepts disclosed herein and the claims that follow.

What is claimed is:

1. An electronic device comprising:
a plurality of force sensors each coupled to a slider and configured to generate a respective one of a plurality of sensory signals in response to an external force being applied on the slider;
a raw data processing circuit configured to:
determine a raw position value and a raw force value of the external force based on the plurality of sensory signals; and
linearly map the raw force value to an alpha raw force value inversely related to the raw force value; and
a post processing circuit configured to:
determine a new position value based on the raw position value and the alpha raw force value; and
determine a relative position change between the new position value and a current position value based on a step value determined to reduce position jitter of the slider.

2. The electronic device of claim 1, wherein the post processing circuit is further configured to cause the new position value to be displayed when the relative position change from the current position value is greater than or equal to the step value.

3. The electronic device of claim 1, wherein the raw data processing circuit comprises:
a position calculator circuit configured to determine the raw position value based on the plurality of sensory signals;
a force calculator circuit configured to determine the raw force value based on the determined raw position value and the plurality of sensory signals; and
a transfer function configured to linearly map the raw force value to the alpha raw force value inversely related to the raw force value.

4. The electronic device of claim 3, wherein the position calculator circuit is further configured to determine the raw position value based on a lookup table.

5. The electronic device of claim 1, wherein the post processing circuit comprises:
a filter circuit configured to:
determine a coefficient of a single-order infinite impulse response (IIR) low-pass filter based on the alpha raw force value; and
apply the single-order IIR low-pass filter to the raw position value to thereby determine the new position value; and
a debouncing circuit configured to output a position change signal indicating the relative position change when the determined new position value differs from the current position value by at least the step value.

6. The electronic device of claim 5, wherein the debouncing circuit is further configured to generate a haptic trigger when the relative position change is not equal to zero.

7. The electronic device of claim 5, wherein the post processing circuit further comprises a position history register configured to store the current position value and provide the stored current position value to the filter circuit and the debouncing circuit is further configured to continuously update the current position value in the position history register.

8. A method for reducing slider position jitter in an electronic device comprising:
generating a plurality of sensory signals in response to an external force being applied on a slider;
determining a raw position value and a raw force value of the external force based on the plurality of sensory signals;
linearly mapping the raw force value to an alpha raw force value inversely related to the raw force value;
determining a new position value based on the raw position value and the alpha raw force value; and
determining a relative position change between the new position value and a current position value based on a step value determined to reduce position jitter of the slider.

9. The method of claim 8, further comprising causing the new position value to be displayed when the relative position change from the current position value is greater than or equal to the step value.

10. The method of claim 8, further comprising determining the raw position value based on a lookup table.

11. The method of claim 8, further comprising:
determining a coefficient of a single-order infinite impulse response (IIR) low-pass filter based on the alpha raw force value;
applying the single-order IIR low-pass filter to the raw position value to thereby determine the new position value; and
outputting a position change signal indicating the relative position change when the determined new position value differs from the current position value by at least the step value.

12. The method of claim 11, further comprising generating a haptic trigger when the relative position change is not equal to zero.

13. The method of claim 11, further comprising storing the current position value and continuously updating the current position value.

14. A wireless device comprising:
a plurality of force sensors each coupled to a slider and configured to generate a respective one of a plurality of sensory signals in response to an external force being applied on the slider;
a raw data processing circuit configured to:
determine a raw position value and a raw force value of the external force based on the plurality of sensory signals; and
linearly map the raw force value to an alpha raw force value inversely related to the raw force value; and
a post processing circuit configured to:
determine a new position value based on the raw position value and the alpha raw force value; and
determine a relative position change between the new position value and a current position value based on a step value determined to reduce position jitter of the slider.

15. The wireless device of claim 14, wherein the post processing circuit is further configured to cause the new position value to be displayed when the relative position change from the current position value is greater than or equal to the step value.

16. The wireless device of claim 14, wherein the raw data processing circuit comprises:
a position calculator circuit configured to determine the raw position value based on the plurality of sensory signals;
a force calculator circuit configured to determine the raw force value based on the determined raw position value and the plurality of sensory signals; and
a transfer function configured to linearly map the raw force value to the alpha raw force value inversely related to the raw force value.

17. The wireless device of claim 16, wherein the position calculator circuit is further configured to determine the raw position value based on a lookup table.

18. The wireless device of claim 16, wherein the post processing circuit comprises:
a filter circuit configured to:
determine a coefficient of a single-order infinite impulse response (IIR) low-pass filter based on the alpha raw force value; and
apply the single-order IIR low-pass filter to the raw position value to thereby determine the new position value; and
a debouncing circuit configured to output a position change signal indicating the relative position change when the determined new position value differs from the current position value by at least the step value.

19. The wireless device of claim 18, wherein the debouncing circuit is further configured to generate a haptic trigger when the relative position change is not equal to zero.

20. The wireless device of claim 18, wherein the post processing circuit further comprises a position history register configured to store the current position value and provide the stored current position value to the filter circuit and the debouncing circuit is further configured to continuously update the current position value in the position history register.
